(19) United States
(12) Patent Application Publication
(10) Pub. No.: US 2017/0203978 A1
(43) Pub. Date: Jul. 20, 2017

(54) TREATMENT METHODS FOR RECYCLING DYEING RESIDUAL LIQUIDS

(71) Applicant: GUANGDONG SHUNDE TIANXIN ENVIRONMENTAL PROTECTION TECHNOLOGIES CO. LTD., FOSHAN CITY (CN)

(72) Inventors: Di CHENG, FOSHAN CITY (CN); Yunchuan OU, FOSHAN CITY (CN); Hongwei YANG, FOSHAN CITY (CN); Jingshu ZHAO, Foshan (CN)

(21) Appl. No.: 15/000,047

(22) Filed: Jan. 19, 2016

(51) Int. Cl. C02F 1/26; C02F 1/66; C02F 1/28

(52) U.S. Cl. CPC C02F 1/26; C02F 1/285; C02F 1/66; C02F 2101/308

(57) ABSTRACT

The present invention provides a treatment method for recycling dyeing residual liquids. The method comprises the following steps: adding an organic liquid into the acidic dyeing residual liquids to separate colored substances in the dyeing residual liquids into the organic liquid so as to decolorize the dyeing residual liquids; and, recycling the decolorized dyeing residual liquids in accordance with a dyeing process.

### BACKGROUND Of TIE INVENTION

1. Field of the Invention

The present invention relates to wastewater treatment technology in printing and dyeing industry, and more particularly to a treatment method for recycling dyeing residual liquids.

2. Description of the Prior Art

Dyeing residual liquids are dyeing wastewater, except washing water, from a dyeing process. The dyeing residual liquids, especially dyeing residual liquids of reactive dyes, have a high concentration of pollutants, of which the main components are unreacted dyes and its hydrolyzed products, sodium carbonate and salts. The dyeing residual liquids have become one of the difficulty treated wastewater due to its high salt content and high chroma.

In traditional treatments of dyeing wastewater, dyeing residual liquids with high salt content are mixed with wastewater from other processes, diluted by using dilution method to reduce salt content and chroma, and then treated through physics-chemical treatment, biochemistry treatment and advanced treatment. However, these treatments have problems of high investments, high operating costs and unstable effects.

Hence, it is necessary to provide a new treatment method for dyeing residual liquids, which can decolorize the dyeing residual liquids efficiently and reduce burden of sewage disposal by recycling the decolorized dyeing residual liquids in accordance with a dyeing process.

### BRIEF SUMMARY OF THE INVENTION

The first object of the present invention is to provide a treatment method for recycling dyeing residual liquids.

The main idea of the present invention is to decolorize the dyeing residual liquids by loading colored substances in the dyeing residual liquids into the organic liquid and reserve salts in the dyeing residual liquids at the same time, so that the decolorized dyeing residual liquids can be reused in dyeing process for purpose of reducing salts consumption. Meanwhile, the organic liquid is regenerated by using alkali liquor for recycling.

To achieve the above object, the present invention provides a treatment method for recycling dyeing residual liquids, which comprises the following steps: adding an organic liquid into an acidic dyeing residual liquids to load colored substances in the dyeing residual liquids into the organic liquid so as to decolorize the dyeing residual liquids; and, recycling the decolorized dyeing residual liquids in accordance with a dyeing process.

In one embodiment of the present invention, the treatment method comprises the following steps:

(1) adjusting a pH value of the dyeing residual liquids to be in a range from 1 to 4;

(2) adding the organic liquid into the adjusted dyeing residual liquids for decolorizing treatment, and then obtaining a loaded organic liquid and a recycled dyeing residual liquids after standing and separation;

(3) recycling the recycled dyeing residual liquids obtained in the step (2) in accordance with a dyeing process;

(4) adding an alkali liquor into the loaded organic liquid obtained in the step (2) to separate the colored substances into the alkali liquor so as to obtain a reusable organic liquid for the &colorizing treatment in the step (2).

In one preferred embodiment of the present invention, the organic liquid is a mixture of reactant and diluent, and wherein the reactant is selected from tributyl phosphate (TBP), trioctyl phosphate (TOP), tri-n-octylphosphine oxide (TOPO), triocylamine, N235 or N503 and the diluen is selected from kerosene, aviation kerosene or sulfonated kerosene.

In one preferred embodiment of the present invention, the volume ratio of the reactant to the diluent is in a range of (2˜4):(6˜8).

In one preferred embodiment of the present invention, in the step (2), the organic liquid is added into the adjusted dyeing residual liquids with a volume ratio of the organic liquid to the adjusted dyeing residual liquids being in a range of 1:(30˜40).

In one preferred embodiment of the present invention, the decolorizing treatment in the step (2) has a processing time in a range from 30 to 60 minutes.

In one preferred embodiment of the present invention, the standing and separation in the step (2) has a processing time in a range from 30 to 60 minutes.

In one preferred embodiment of the present invention, the alkali liquor in the step (4) is selected from sodium hydroxide solution, potassium hydroxide solution or sodium carbonate solution, of which the mass concentration is in a range from 8 to 20%.

In one preferred embodiment of the present invention, in the step (4), the alkali liquor is added into the loaded organic liquid with a volume ratio of the alkali liquor to the loaded organic liquid being in a range of 1:(4˜6).

In one preferred embodiment of the present invention, the reaction between the alkali liquor and the loaded organic liquid has a processing time in a range from 10 to 30 minutes.

In one preferred embodiment of the present invention, a treatment method for recycling dyeing residual liquids is provided, which comprises the following steps:

(1) adjusting a pH value of the dyeing residual liquids to be in a range from 1 to 4;

(2) adding the organic liquid into the adjusted dyeing residual liquids for decolorizing treatment, and then obtaining a loaded organic liquid and a recycled dyeing residual liquids after standing and separation; wherein, the organic liquid is added into the adjusted dyeing residual liquids with a volume ratio of the organic liquid to the adjusted dyeing residual liquids being in a range of 1:(30˜40); the organic liquid is a mixture of reactant and diluent, wherein the volume ratio of the reactant to the diluent is in a range of (2˜4):(6˜8); the reactant is selected from tributyl phosphate (TBP), trioctyl phosphate (TOP), tri-n-octylphosphine oxide (TOPO), triocylamine, N235 or N503; and, the diluen is selected from kerosene, aviation kerosene or sulfonated kerosene;

(3) recycling the recycled dyeing residual liquids obtained in the step (2) in accordance with a dyeing process;

(4) adding an alkali liquor into the loaded organic liquid obtained in the step (2) to separate the colored substances into the alkali liquor so as to obtain a reusable organic liquid for the decolorizing treatment in the step (2); wherein, the alkali liquor is added into the loaded organic liquid with a volume ratio of the alkali liquor to the loaded organic liquid being in a range of 1:(4˜6); and, the alkali liquor is selected from sodium hydroxide solution, potassium hydroxide solution or sodium carbonate solution, of which the mass concentration is in a range from 8 to 20.

In the above mentioned embodiment, the decolorizing treatment in the step (2) has a processing tune in a range from 30 to 60 minutes, the standing and separation in the step (2) has a processing time in a range from 30 to 60 minutes; and, the reaction between the alkali liquor and the loaded organic liquid in the step (4) has a processing time in a range from 10 to 30 minutes.

It should be noted that reagents disclosed in the present invention are commercially available reagents without special instructions.

In the present invention, the dyeing residual liquids is decolorized by using the organic liquid, so that the dyeing residual liquids have low color degrees and the decolorization rate is over 99%. Meanwhile, salts in the dyeing residual liquids are reserved according to the present invention, so that the decolorized saliferous dyeing residual liquids can be reused in dyeing process. As a result, according to the present invention, salts in the dyeing residual liquids are used rationally and effectively in order to reduce salts consumption and avoid emission of high-salt and high-color degrees residual liquids, so that production cost and burden of sewage disposal are reduced.

The positive effects of the present invention are that:

(1) according to one aspect of the present invention, the present invention can achieve good economic benefits, which is represented in a way that high-salt and high-color degrees residual liquids are decolorized separately with a decolorization rate of over 99%, so that the decolorized residual liquids and the salts in the residual liquids can be reused in dyeing process. Based on experimental data, reusing one ton of the residual liquids can save more than 40 Yuan. Moreover, costs of heat will be reduced by reusing waste heat of the residual liquids while costs of wastewater discharge and fresh water will be reduced by reusing the residual liquids.

(2) according to one aspect of the present invention, the present invention can achieve good environmental benefits, which is represented in a way that most of salts in the residual liquids are prevented from directly discharging into water body to achieve significant effects of emission reduction. Meanwhile, wastewater treatments will reach standards more easily since most of salts and dyes are intercepted at the source. Especially for companies that reuse gray-water by using films technology, operating costs will be significantly decreased due to the reduced salt content.

(3) according to one aspect of the present invention, the present invention can achieve advantages in labor costs. Since salts are added by manual in the current dyeing process, working intensity of adding salts will be decreased by hundreds of tons through reusing the dyeing residual liquids.

### DETAILED DESCRIPTION OF THE PREFERRED EMBODIMENTS

Embodiments, for purposes of explanation, are set forth in order to provide a thorough understanding of the present invention and not to limit the technical solution of the present invention.

### Example 1

A treatment method for recycling dyeing residual liquids is provided in this embodiment, which comprises the following steps: adding an organic liquid into acidic dyeing residual liquids to load colored substances in the dyeing residual liquids into the organic liquid so as to decolorize the dyeing residual liquids; and, recycling the decolorized dyeing residual liquids in accordance with a dyeing process.

The method is that: collecting 6000 ml of the dyeing residual liquids into a reactor, and then loading sulphuric acid slowly to adjust the pH value of the dyeing residual liquids to be in a range of 3 to 4, mixing tributyl phosphate (TBP) and aviation kerosene with a volume ratio of 2:8 to obtain the organic liquid; introducing 200 ml of the organic liquid into the adjusted dyeing residual liquid for decolorization, reacting for 30 minutes followed by standing for 30 minutes to separate the decolorized dyeing residual liquids and the organic liquid loaded with dyes; and, introducing 35 ml of sodium hydroxide solution with a mass concentration of 20%, and then reacting for 30 minutes to catch the dyes loaded in the organic liquid into the sodium hydroxide solution, so that the organic liquid is regenerated for recycling in the decolorizing treatment.

Hereinafter, the decolorized dyeing residual liquids are reused to verify feasibility of reusage.

The formulation of dyeing is as follows.

Everton Yellow 3RS H/C: 0.95%

Everton brilliant Red 3BS H/C: 1.02%

Liyuan Black 133%: 2.2%

Sodium sulfate: none; and,

Sodium carbonate: 20 g/L.

Liquor ratio is 1:13, and dyeing condition is 60° C.×60 minutes, half-bleached cotton cloth.

Results: color distortion ΔE is 0.19 and slight color uneven occurs. The overall result of dyeing is acceptable.

### Example 2

A treatment method for recycling dyeing residual liquids is provided in this embodiment, which comprises the following steps: adding an manic liquid into acidic dyeing residual liquids to load colored substances in the dyeing residual liquids into the organic liquid so as to decolorize the dyeing residual liquids; and, recycling the decolorized dyeing residual liquids in accordance with a dyeing process.

The method is that: collecting 6000 ml of the dyeing residual liquids into a reactor, and then loading sulphuric acid slowly to adjust the pH value of the dyeing residual liquids to be in a range of 3 to 4; mixing trioctyl phosphate (TOP) and aviation kerosene with a volume ratio of 3:7 to obtain the organic liquid; introducing 160 ml of the organic liquid into the adjusted dyeing residual liquid for decolorization, reacting for 45 minutes followed by standing for 45 minutes to separate the decolorized dyeing residual liquids and the organic liquid loaded with dyes; and, introducing 40 ml of potassium hydroxide solution with a mass concentration of 15%, and then reacting for 20 minutes to catch the dyes loaded in the organic liquid into the sodium hydroxide solution, so that the organic liquid is regenerated for recycling in the decolorizing treatment.

The decolorized dyeing residual liquids are reused to verify feasibility of reusage. The formulation of dyeing in this example is the same as that in example 1. Results: color distortion ΔE is 0.15 and slight color uneven occurs. The overall result of dyeing is acceptable.

### Example 3

A treatment method for recycling dyeing residual liquids is provided in this embodiment, which comprises the following steps: adding an organic liquid into acidic dyeing residual liquids to load colored substances in the dyeing residual liquids into the organic liquid so as to decolorize the dyeing residual liquids; and, recycling the decolorized dyeing residual liquids in accordance with a dyeing process.

The method is that: collecting 6000 ml of the dyeing residual liquids into a reactor, and then loading sulphuric acid slowly to adjust the pH value of the dyeing residual liquids to be in a range of 3 to 4; mixing tri-n-octylphosphine oxide (TOPO) and sulfonated kerosene with a volume ratio of 4:6 to obtain the organic liquid; introducing 150 ml of the organic liquid into the adjusted dyeing residual liquid for decolorization, reacting for 60 minutes followed by standing for 60 minutes to separate the decolorized dyeing residual liquids and the organic liquid loaded with dyes; and, introducing 30 ml of sodium carbonate solution with a mass concentration of 10%, and then reacting for 30 minutes to catch the dyes loaded in the organic liquid into the sodium hydroxide solution, so that the organic liquid is regenerated for recycling in the decolorizing treatment.

The decolorized dyeing residual liquids are reused to verify feasibility of reusage. The formulation of dyeing in this example is the same as that in example 1. Results: color distortion ΔE is 0.26 and slight color uneven occurs. The overall result of dyeing is acceptable.

### Example 4

A treatment method for recycling dyeing residual liquids is provided in this embodiment, which comprises the following steps: adding an organic liquid into acidic dyeing residual liquids to load colored substances in the dyeing residual liquids into the organic liquid so as to decolorize the dyeing residual liquids; and, recycling the decolorized dyeing residual liquids in accordance with a dyeing process.

The method is that: collecting 6000 ml of the dyeing residual liquids into a reactor, and then loading sulphuric acid slowly to adjust the pH value of the dyeing residual liquids to be in a range of 3 to 4; mixing tri-n-octylphosphine oxide (TOPO) and kerosene with a volume ratio of 3:7 to obtain the organic liquid; introducing 160 ml of the organic liquid into the adjusted dyeing residual liquid for decolorization, reacting for 60 minutes followed by standing for 60 minutes to separate the decolorized dyeing residual liquids and the organic liquid loaded with dyes; and, introducing 40 ml of potassium hydroxide solution with a mass concentration of 8%, and then reacting for 10 minutes to catch the dyes loaded in the organic liquid into the sodium hydroxide solution, so that the organic liquid is regenerated for recycling in the decolorizing treatment.

The decolorized dyeing residual liquids are reused to verify feasibility of reusage. The formulation of dyeing in this example is the same as that in example 1. Results: color distortion ΔE is 0.31 and slight color uneven occurs. The overall result of dyeing is acceptable.

### Example 5

A treatment method for recycling dyeing residual liquids is provided in this embodiment, which comprises the following steps: adding an organic liquid into acidic dyeing residual liquids to load colored substances in the dyeing residual liquids into the organic liquid so as to decolorize the dyeing residual liquids; and, recycling the decolorized dyeing residual liquids in accordance with a dyeing process.

The method is that: collecting 6000 ml of the dyeing residual liquids into a reactor, and then loading sulphuric acid slowly to adjust the pH value of the dyeing residual liquids to be in a range of 3 to 4; mixing tributyl phosphate (TBP) and kerosene with a volume ratio of 3:7 to obtain the organic liquid; introducing 150 ml of the organic liquid into the adjusted dyeing residual liquid for decolorization, reacting for 45 minutes followed by standing for 45 minutes to separate the decolorized dyeing residual liquids and the organic liquid loaded with dyes; and, introducing 30 ml of sodium hydroxide solution with a mass concentration of 15%, and then reacting for 15 minutes to catch the dyes loaded in the organic liquid into the sodium hydroxide solution, so that the organic liquid is regenerated for recycling in the decolorizing treatment.

The decolorized dyeing residual liquids are reused to verify feasibility of reusage. The formulation of dyeing in this example is the same as that in example 1. Results: color distortion ΔE is 0.22 and slight color uneven occurs. The overall result of dyeing is acceptable.

### Example 6

A treatment method for recycling dyeing residual liquids is provided in this embodiment, which comprises the following steps: adding an organic liquid into acidic dyeing residual liquids to load colored substances in the dyeing residual liquids into the organic liquid so as to decolorize the dyeing residual liquids; and, recycling the decolorized dyeing residual liquids in accordance with a dyeing process.

The method is that: collecting 6000 ml of the dyeing residual liquids into a reactor, and then loading sulphuric acid slowly to adjust the pH value of the dyeing residual liquids to be in a range of 3 to 4; mixing trioctyl phosphate (TOP) and sulfonated kerosene with a volume ratio of 2:8 to obtain the organic liquid; introducing 200 ml of the organic liquid into the adjusted dyeing residual liquid for decolorization, reacting for 30 minutes followed by standing for 30 minutes to separate the decolorized dyeing residual liquids and the organic liquid loaded with dyes; and, introducing 50 ml of sodium hydroxide solution with a mass concentration of 10%, and then reacting for 15 minutes to catch the dyes loaded in the organic liquid into the sodium hydroxide solution, so that the organic liquid is regenerated for recycling in the decolorizing treatment.

The decolorized dyeing residual liquids are reused to verify feasibility of reusage. The formulation of dyeing in this example is the same as that in example 1. Results: color distortion ΔE is 0.28 and slight color uneven occurs. The overall result of dyeing is acceptable.

### Example 7

A treatment method for recycling dyeing residual liquids is provided in this embodiment, which comprises the following steps: adding an organic liquid into acidic dyeing residual liquids to load colored substances in the dyeing residual liquids into the organic liquid so as to decolorize the dyeing residual liquids; and, recycling the decolorized dyeing residual liquids in accordance with a dyeing process.

The method is that: collecting 6000 ml of the dyeing residual liquids into a reactor, and then loading sulphuric acid slowly to adjust the pH value of the dyeing residual liquids to be in a range of 1 to 2; mixing triocylamine and kerosene with a volume ratio of 3:7 to obtain the organic liquid; introducing 160 ml of the organic liquid into the adjusted dyeing residual liquid for decolorization, reacting for 60 minutes followed by standing for 60 minutes to separate the decolorized dyeing residual liquids and the organic liquid loaded with dyes; and, it 40 ml of sodium hydroxide solution with a mass concentration of 15%, and then reacting for 10 minutes to catch the dyes loaded in the organic liquid into the sodium hydroxide solution, so that the organic liquid is regenerated for recycling in the decolorizing treatment.

The decolorized dyeing residual liquids are reused to verify feasibility of reusage, the formulation of dyeing in this example is the same as that in example 1. Results: color distortion ΔE is 0.16 and slight color uneven occurs. The overall result of dyeing is acceptable.

### Example 8

A treatment method for recycling dyeing residual liquids is provided in this embodiment, which comprises the following steps: adding an organic liquid into acidic dyeing residual liquids to load colored substances in the dyeing residual liquids into the organic liquid so as to decolorize the dyeing residual liquids; and, recycling the decolorized dyeing residual liquids in accordance with a dyeing process.

The method is that: collecting 6000 ml of the dyeing residual liquids into a reactor, and then loading sulphuric acid slowly to adjust the pH value of the dyeing residual liquids to be in a range of 2 to 3; mixing N235 and kerosene with a volume ratio of 3:7 to obtain the organic liquid; introducing 150 ml of the organic liquid into the adjusted dyeing residual liquid for decolorization, reacting for 45 minutes followed by standing for 45 minutes to separate the decolorized dyeing residual liquids and the organic liquid loaded with dyes; and, introducing 30 ml of potassium hydroxide solution with a mass concentration of 15%, and then reacting for 15 minutes to catch the dyes loaded in the organic liquid into the sodium hydroxide solution, so that the organic liquid is regenerated for recycling, in the decolorizing treatment.

The decolorized dyeing residual liquids are reused to verify feasibility of reusage. The formulation of dyeing in this example is the same as that in example 1. Results: color distortion ΔE is 0.26 and slight color uneven occurs. The overall result of dyeing is acceptable.

### Example 9

A treatment method for recycling dyeing residual liquids is provided in this embodiment, which comprises the following steps: adding an organic liquid into acidic dyeing residual liquids to load colored substances in the dyeing residual liquids into the organic liquid so as to decolorize the dyeing residual liquids; and, recycling the decolorized dyeing residual liquids in accordance with a dyeing process.

The method is that: collecting 6000 ml of the dyeing residual liquids into a reactor, and then loading sulphuric acid slowly to adjust the pH value of the dyeing residual liquids to be in a range of 3 to 4; mixing N503 and sulfonated kerosene with a volume ratio of 2:8 to obtain the organic liquid; introducing 200 ml of the organic liquid into the adjusted dyeing residual liquid for decolorization, reacting for 30 minutes followed by standing for 30 minutes to separate the decolorized dyeing residual liquids and the organic liquid loaded with dyes; and, introducing 50 ml of sodium hydroxide solution with a mass concentration of 10%, and then reacting for 20 minutes to catch the dyes loaded in the organic liquid into the sodium hydroxide solution, so that the organic liquid is regenerated for recycling in the decolorizing treatment.

The decolorized dyeing residual liquids are reused to verify feasibility of reusage. The formulation of dyeing in this example is the same as that in example Results: color distortion ΔE is 0.30 and slight color uneven occurs. The overall result of dyeing is acceptable.

In the present invention, the dyeing residual liquids is decolorized by using the organic liquid, so that the dyeing residual liquids have low color degrees and the decolorization rate is over 99%. Meanwhile, salts in the dyeing residual liquids are reserved according to the present invention, so that the decolorized saliferous dyeing residual liquids can be reused in dyeing process. As a result, according to the present invention, salts in the dyeing residual liquids are used rationally and effectively in order to reduce salts consumption and avoid emission of high-salt and high-color degrees residual liquids, so that production cost and burden of sewage disposal are reduced.

The present invention is supported by South Wisdom Valley Innovative Research Team Program.

The present invention has been described with relative embodiments which are examples of the present invention only. It should be noted that the embodiments disclosed are not the limit of the scope of the present invention. Conversely, modifications to the scope and the spirit of the claims, as well as the equal of the claims, are within the scope of the present invention.

What is claimed is:

1. A treatment method for recycling dyeing residual liquids, comprising the following steps: adding an organic liquid into an acidic dyeing residual liquids to load colored substances in the dyeing residual liquids into the organic liquid so as to decolorize the dyeing residual liquids; and, recycling the decolorized dyeing residual liquids in accordance with a dyeing process.

2. The treatment method according to claim 1, wherein the treatment method comprises the following steps:
(1) adjusting a pH value of the dyeing residual liquids to be in a range from 1 to 4;
(2) adding the organic liquid into the adjusted dyeing residual liquids for deodorizing treatment, and then obtaining a loaded organic liquid and a recycled dyeing residual liquids after standing and separation;
(3) recycling the recycled dyeing residual liquids obtained in the step (2) in accordance with a dyeing process;
(4) adding an alkali liquor into the loaded organic liquid obtained in the step (2) to separate the colored substances into the alkali liquor so as to obtain a reusable organic liquid for the decolorizing treatment in the step (2).

3. The treatment method according to claim 2, wherein the organic liquid is a mixture of reactant and diluent, and wherein the reactant is selected from tributyl phosphate (TBP), trioctyl phosphate (TOP), tri-n-octylphosphine oxide (TOPO), triocylamine, N235 or N503 and the diluen is selected from kerosene, aviation kerosene or sulfonated kerosene.

4. The treatment method according to claim 3, wherein the volume ratio of the reactant to the diluent is in a range of (2˜4):(6˜8).

5. The treatment method according to claim 2, wherein in the step (2), the organic liquid is added into the adjusted dyeing residual liquids with a volume ratio of the organic liquid to the adjusted dyeing residual liquids being in a range of 1:(30˜40).

6. The treatment method according to claim 2, wherein the decolorizing treatment in the step (2) has a processing time in a range from 30 to 60 minutes.

7. The treatment method according to claim 2, wherein the standing and separation in the step (2) has a processing time in a range from 30 to 60 minutes.

8. The treatment method according to claim 2, wherein the alkali liquor in the step (4) is selected from sodium hydroxide solution, potassium hydroxide solution or sodium carbonate solution, of which the mass concentration is in a range from 8 to 20%.

9. The treatment method according to claim 2, wherein in the step (4), the alkali liquor is added into the loaded organic liquid with a volume ratio of the alkali liquor to the loaded organic liquid being in a range of 1:(4˜6).

10. The treatment method according to claim 2, wherein the reaction between the alkali liquor and the loaded organic liquid has a processing time in a range from 10 to 30 minutes.
